(19) United States
(12) Patent Application Publication
(10) Pub. No.: US 2009/0150255 A1
(43) Pub. Date: Jun. 11, 2009

(54) Method For Fractional Vineyard Ownership and Distribution Therefrom

(76) Inventors: Patrick W. Baker, Sonoma, CA (US); John A. Kelly, Sonoma, CA (US)

Correspondence Address: GIANNA G. KELLY, 922 1ST STREET WEST, SONOMA, CA, 95476, US

(21) Appl. No.: 12/329,425

(22) Filed: Dec. 5, 2008

Related U.S. Application Data
(60) Provisional application No. 60/992,445, filed on Dec. 5, 2007.

(51) Int. Cl. G06Q 30/00; G06Q 40/00; G06Q 90/00

(52) U.S. Cl. 705/26; 705/35

(57) ABSTRACT

A method of fractional vineyard ownership and distribution of the wine produced therefrom where individuals purchase an interest in a business entity, receiving a fractional ownership of a winemaking enterprise. Thusly, aggregating their capital and allowing for deployment of same to different licensed business entities at the grape growing, fermentation, bottling and labeling, wholesale, and retail phases of the wine production process.

### CROSS-REFERENCE TO RELATED APPLICATIONS

This application claims the benefit of provisional patent application Ser. No. 60/992,445, filed Dec. 5, 2007 by the present inventors.

### FEDERALLY SPONSORED RESEARCH

Not Applicable.

### SEQUENCE LISTING OR PROGRAM

Not Applicable.

### FIELD OF THE INVENTION

The present invention relates to a method for fractional vineyard ownership and distribution of the wine produced therefrom.

### BACKGROUND OF THE INVENTION

There exists a desire among certain investors to be involved in the growing and making of wine, without the large expenditure of capital required to establish their own vineyards and winery. By partnering together, and contracting with vineyard management and winemaking services, this goal can be accomplished. However, several challenges are presented, namely, the regulations governing the purchase and sale of alcoholic beverages as established by different regulatory authorities. The method described herein will overcome these challenges and provide a viable business opportunity for fractional vineyard ownership.

Wine clubs are well-know in the wine industry, however, these provide little more than a subscription to regular wine purchases and perhaps dinner with the winemaker. Currently in the wine industry there exists a large gap between becoming a wine club member and owning a winery. This invention provides an intermediate level where individuals can take an ownership stake in the production of wine, and enjoy the benefits associated therewith.

### SUMMARY OF THE INVENTION

The object of the present invention is to provide investors with an opportunity to purchase a fractional ownership in a vineyard and the wine subsequently produced therefrom while complying with all agricultural and alcohol distribution regulations.

The invention consists of the formation of multiple business entities; each one has a separate and distinct capital structure and holds the regulatory licenses necessary for a different stage of the wine production process. There is a specialized flow of capital between these entities in order to provide a worthwhile fractional ownership opportunity to the investor, while complying with all state and federal regulations that control the production and distribution of wine.

The aggregated capital of different fractional owners, results in a structure of investors that allows the same pool of capital to be deployed to different licensed entities at the fermentation, labeling, wholesale, and retailing phases of the distribution process, allowing practical control of the product of the vineyards while minimizing the risk of adverse financial impact

In another embodiment, the aggregated capital allows different fractional owners to pursue customers at the retail level, while allowing a financial benefit or burden to be passed directly to the fractional owner.

Additionally, the investors are able to track data relating to the grapes and subsequent wine via a computer database that is maintained by one of the business entities and accessible via the Internet. That data include, but are not limited to, items such as weather data, sugar levels, trellis structure, harvest date, weight, fermentation length, fermentation temperature, press date, alcohol level and sensory evaluations.

### BRIEF DESCRIPTION OF THE DRAWINGS

The best mode, currently contemplated for the present invention, is illustrated in the following detailed description taken in conjunction with the appended drawings, in which reference numbers designate the same parts throughout the several views, and wherein:

FIG. 1 is a schematic representation of the exchange of capital between the different business entities in accordance with the present invention;

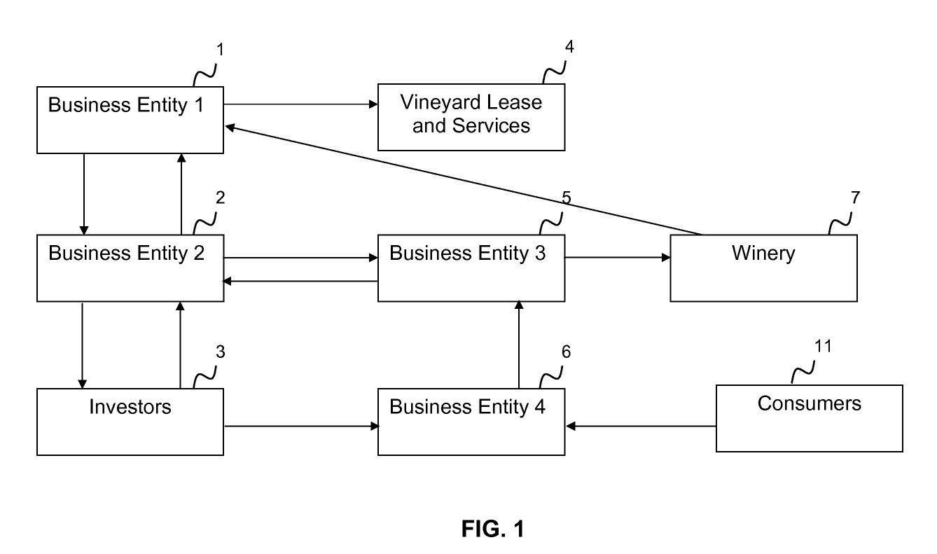

FIG. 2 is a flow diagram of the production and distribution of wine in accordance with the present invention.

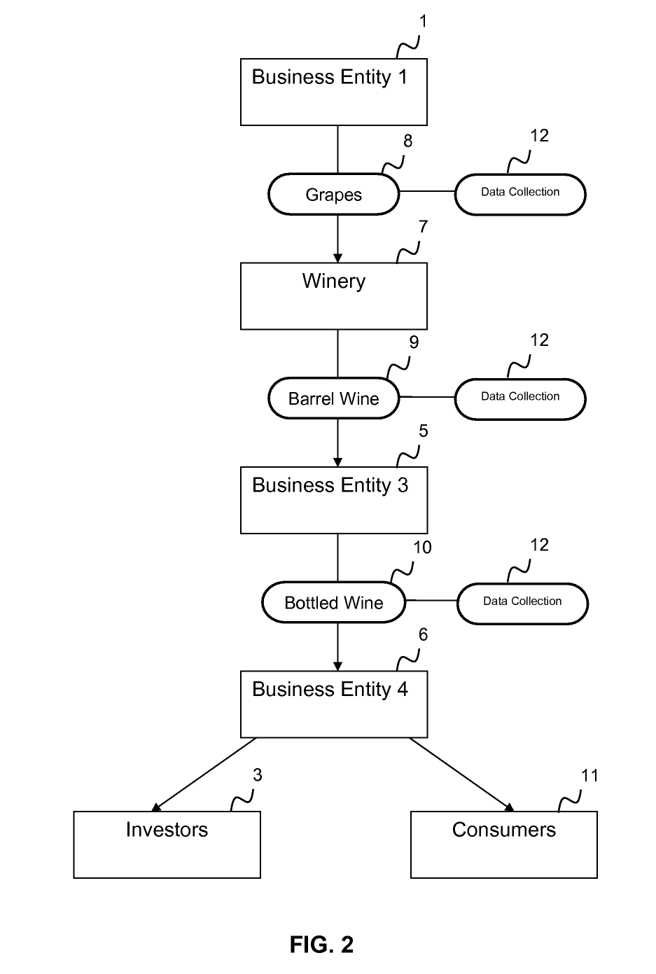

### DETAILED DESCRIPTION

The scope and content of the present invention are not intended to be limited by the foregoing descriptions, and are to be defined only by the appended claims and their legal equivalents.

A first business entity 1, such as a corporation, contracts with vineyard owners 4, vineyard management services 4 and winemaking facilities 7, and in addition holds licenses relevant to operating in an agricultural purchase context, and maintains control of the raw agricultural output until processed. This first business entity 1 and individual investors 3 purchase an interest in a second business entity 2, such as a partnership.

Using capital supplied by the investors 3 buying in, the second business entity 2 enters into a relationship with the first business entity 1 for access to the first business entity's 1 vineyard 4 and winery 7 contracts. This relationship provides capital to the first business entity 1.

The first business entity 1, delivers the grapes 8, produced from the vineyards 4 with which it has contracted, to a winery 7. The winery 7 purchases the grapes 8 from the first business entity 1. Upon completing its preprocessing activities the first business entity 1 returns the proceeds from this sale to the second business entity 2, which in turn loans the capital to a third business entity 3 possessing all licenses necessary to provide for the wholesale distribution of the processed agricultural output.

The winery 7 completes the fermentation process and the third business entity 3 purchases the finished wine 9 from the winery 7. A fourth business 6, which holds all licenses necessary to provide for the retail distribution of the wine, purchases the wine 9 from the third business entity 3, the proceeds of which are utilized by the third business entity 3 to repay the loan from second business entity 2. The fourth business entity 4 distributes the bottled wine 10 to the individual investors 3, and may in addition; retail the wine to consumers 11, on behalf of the investors 3.

While this process is going on the first business entity 1, is involved in data collection 12. This data collection 12 consists of various metrics related to growing of the grapes 8, the production of barrel wine 9 and finally the bottled wine 10. These metrics are maintained in a computer database which is accessible via the Internet, allowing the investors 3 to have up-to-date information about how the grapes 8 and subsequently the wine 9 and 10, are developing.

I claim:

1. A method for fractional vineyard ownership and distribution of the wine produced therefrom, said method comprising:
a) A first business entity purchasing at least one vineyard lease, arranging for vineyard management services, and contracting with at least one winery;
b) Said first business entity holding relevant agricultural licenses, allowing said first business entity to own the grapes produced from said vineyard leases;
c) Said first business entity, and individual investors purchasing interests in a second business entity;
d) Said second business entity paying said first business entity in exchange for access to said vineyard lease, said vineyard management services, and said winery;
e) Said winery purchasing said grapes from said first business entity;
f) Said first business entity delivering proceeds of the sale of said grapes to said second business entity;
g) Said winery producing wine from said grapes;
h) Said second business entity loaning said proceeds to a third business entity;
h) Said third business entity holding relevant wholesale licenses, and purchasing said wine from said winery;
i) Said third business entity bottling and labeling said wine;
j) A fourth business entity, holding all relevant retail licenses, and purchasing said wine from said third business entity;
k) Said third business entity repaying said proceeds to said second business entity;
l) Said second business entity distributing said capital to said first business entity and said individual investors;
m) Said fourth business entity distributing said wine.

2. The method of claim 1 wherein said fourth business entity sells said wine to said individual investors.

3. The method of claim 1 wherein said fourth business entity sells said wine to retail consumers.

4. A method for fractional vineyard ownership and distribution of the wine produced therefrom, said method comprising:
a) A first business entity purchasing at least one vineyard lease, arranging for vineyard management services, and contracting with at least one winery;
b) Said first business entity holding relevant agricultural licenses, allowing said first business entity to own the grapes produced from said vineyard leases;
c) Said first business entity maintaining a computer database, which may be accessed via the Internet, containing metrics for monitoring said grapes;
d) Said first business entity, and individual investors purchasing interests in a second business entity;
e) Said second business entity paying said first business entity in exchange for access to said vineyard lease, said vineyard management services, said computer database, and said winery;
f) Said winery purchasing said grapes from said first business entity;
g) Said first business entity delivering proceeds of the sale of said grapes to said second business entity;
h) Said winery producing wine from said grapes;
i) Said first business entity adding metrics for monitoring said wine to said computer database;
j) Said second business entity loaning said proceeds to a third business entity;
k) Said third business entity holding relevant wholesale licenses, and purchasing said wine from said winery;
l) Said third business entity bottling and labeling said wine;
m) A fourth business entity, holding all relevant retail licenses, and purchasing said wine from said third business entity;
n) Said third business entity repaying said proceeds to said second business entity;
o) Said second business entity distributing said capital to said first business entity and said individual investors;
p) Said fourth business entity distributing said wine.

5. The method of claim 4 wherein said fourth business entity sells said wine to said individual investors.

6. The method of claim 4 wherein said fourth business entity sells said wine to retail consumers.

7. The method of claim 4 wherein said first business entity employs a handheld wireless device for transmitting said metrics to said database.
